(19) United States
(12) Patent Application Publication
(10) Pub. No.: US 2020/0204737 A1
(43) Pub. Date: Jun. 25, 2020

(54) IMAGE CAPTURING DEVICE

(71) Applicant: Arnold & Richter Cine Technik GmbH & Co. Betriebs KG, München (DE)

(72) Inventor: Alexander Keerl, München (DE)

(21) Appl. No.: 16/718,536

(22) Filed: Dec. 18, 2019

(30) Foreign Application Priority Data
Dec. 19, 2018 (DE) 10 2018 132 965.2

(51) Int. Cl. H04N 5/232

(52) U.S. Cl. CPC H04N 5/232411; H04N 5/232939; H04N 5/23245

(57) ABSTRACT

An image capturing device, in particular a digital video camera or a digital operating microscope, comprises an electronic image sensor, an image signal processing device, a control device, and an electronic display, wherein the image capturing device selectively adopts the an operating mode in which the image sensor is controllable to generate image signals or a standby operation in which the energy consumption of the image capturing device is reduced relative to the operating mode. The electronic display is a currentless information maintaining display. The control device controls the display to display operating state information in the standby mode of the image capturing device that represents an operating state of the image capturing device after exiting the standby mode.

The present invention relates to an image capturing device, in particular to a digital video camera or to a digital operating microscope, having an electronic image sensor, an image signal processing device arranged downstream of the image sensor, a control device, and an electronic display, wherein the image capturing device is configured to selectively adopt an operating mode in which the image sensor is controllable to generate image signals or a standby operation in which the energy consumption of the image capturing device is reduced relative to the operating mode.

Such an image capturing device serves for the recording of image sequences. The image capturing device can have an imaging optics that generates an image of a field of view on the image sensor. The image sensor can generate corresponding electronic image signals in the operating mode of the image capturing device. For this purpose, the image sensor, for example a CMOS sensor, can have a two-dimensional matrix of light sensitive sensor elements. The image signal processing device is connected to an output side of the image sensor and can process the image signals of the image sensor in the operating mode of the image capturing device and can in particular amplify and digitize the image signals, and, for example also interpolate, linearize, or otherwise transform and/or compress the image signals. The processed image signals can be output, in particular in the form of digital image data sets, via a signal output of the image capturing device, in particular in a cabled or wireless manner. Alternatively or additionally, the image signals or digital image data sets can be stored in the image capturing device; for this purpose, the image capturing device can have an integrated image memory or a port for connecting an image memory.

Such an image capturing device can optionally also have an electronic viewfinder or monitor to be able to observe the recording zone or the recorded image sequence. Such an image capturing device further comprises the electronic display at which, for example, an operating state of the image capturing device can be displayed to the user. The control device can control different components of the image capturing device, in particular the image sensor, the image signal processing device, and/or the electronic display. The control device can be formed by a single control unit or by a plurality of units. The image capturing device can have an input device via which a user can input corresponding commands or settings or can transmit them to the control device. In addition to the operating mode that the image capturing device can adopt to generate and process image signals in the described manner, the image capturing device can adopt at least one standby mode in which the energy consumption is reduced with respect to the operating mode. The standby mode can, for example, be a shutdown mode or an energy-saving mode.

It is important for a large number of applications that the image capturing device is operational fast and error-free. It is in particular important that the image capturing device is operated at the correct settings to ensure a high image quality. Digital video cameras for the production of cinema movies can, for example, have a complex design, with a plurality of different operating parameters being able to be set and adapted, which, however, requires a certain time effort and corresponding technical knowledge of the user. In medical applications such as in a digital operating microscope or a digital endoscope, it is of very great importance that the operation of the image capturing device also takes place without error in a stressed situation.

It is an object of the invention to provide an image capturing device that can be operated fast and error-free starting from a standby mode.

This object is satisfied by an image capturing device having the features of claim 1.

In such an image capturing device, the electronic display is configured as a currentless information maintaining display that maintains displayed information in a currentless manner, and the control device controls the display to display operating state information in the standby state of the image capturing device that represents an operating state of the image capturing device after exiting the standby mode.

A currentless information maintaining display is to be understood as an electronically controllable display that is configured to maintain last displayed information without any or with only a minimal supply with electrical energy, unlike a liquid crystal display or light emitting diode display, for instance. Such a currentless information maintaining display can in particular be so-called electronic paper, that is a display using electronic ink (“e-ink display”). Such electronic paper can in particular be a display based on the principle of electrophoresis with microcapsules that, for example, contain positively charged white particles and negatively charged black particles in a transparent viscous polymer. The representation is changed by a brief application of an electric voltage and then remains stable over a longer time period without a voltage having to be applied or an electric current having to flow constantly. The currentless information maintaining display can in particular be configured for displaying text information and numerical information.

In the operating mode of the image capturing device, the display can display different information by a corresponding electronic control. At least in the standby mode of the image capturing device, operating state information that represents an operating state of the image capturing device occurring after a subsequent exiting the standby mode is displayed on the display. For this purpose, the control device can correspondingly control the display before or on the transition into the standby mode such that this displaying of the operating state information is maintained in the standby mode. The displaying of the operating state information can in particular be permanently maintained in the standby mode.

The displaying of the operating state information in the standby mode of the image capturing device can in particular take place automatically, that is without any special action of the user.

The user can thus also quickly and directly acquire knowledge in the standby mode of the image capturing device, for example, on which operating state the image capturing device will adopt (at the latest) on a new transition into the operating mode. The respective operating state can in particular be based on a stored preset that enables or assists a fast and error-free use of the image capturing device after a restart. The displayed operating state information can, for example, also represent an operating state the image capturing device has adopted before the adoption of the standby mode, in particular based on a setting last selected by the user (for instance, a specific operating parameter). Work can thus be continued fast with the last selected setting after a restart.

It is therefore possible in this manner to bring information that is relevant to a fast and/or safe putting into operation of the image capturing device to the knowledge of a user even in the standby mode of the image capturing device, in particular while the image capturing device is shut down, with the information being able to be selected in dependence on predefined values and/or on a last adopted changeable operating state of the image capturing device. The user can, for example, hereby be enabled to quickly check whether the image capturing device is currently set such that it can be used as fast as possible and/or with the desired settings after being switched on (change into operating mode).

The control device can flexibly adapt the information displayed on the display in dependence, for example, on predefined settings, last made settings, or last occurring events, in particular in accordance with predefined criteria to also provide a situation-related overview to the user in a completely or largely shut down mode of the image capturing device. As is still to be explained in detail, the displayed operating state information in the standby mode can, for example, comprise important setting values of operating parameters of the image sensor or of the image signal processing device, an indication of last occurring errors, other warning messages, or a checklist for a fast putting into operation of the image capturing device. The user therefore does not have to separately switch on the image capturing device to acquire such information. There is also no need to communicate the respective information to the uses, for instance by labels or manuals. The image capturing device can thus be operated fast and free of error starting from the standby mode.

In some embodiments, the operating state information displayed at the electronic display can represent a state of components of the image capturing device. These components can, for example, be the image sensor, the image signal processing device, and/or the control device, or also other components of the image capturing device (e.g. direction of illumination).

In some embodiments, the operating state information displayed at the electronic display can represent a changeable operating parameter of a component of the image capturing device, in particular of the image sensor and/or of the image signal processing device. These changeable operating parameters can, for example, be a set exposure time, a set f-number, a set light sensitivity value, a set value of the image recording rate, a set white balance value, a set image format of generated image signals or of digital image data sets (e.g. aspect ratio 4:3 or 16:9), or a data format of generated image signals (e.g. “ARRIRAW” data format).

With some image capturing devices, specific operating parameters cannot be changed during ongoing operation, but the image capturing device rather has to be switched off or shut down temporarily for this purpose. With such image capturing devices, a first operating parameter of the image sensor and/or of the image signal processing device (e.g. exposure time, f-number) can therefore be changed by the user in the operating mode of the image capturing device, whereas a second operating parameter of the image sensor and/or of the image signal processing device (e.g. aspect ratio of the image format) can only be changed by the user in that, starting from the operating mode, the image capturing device is temporarily set into the standby mode and subsequently back into the operating mode. With such image capturing devices, the displaying of changeable operating parameters on the display in the standby mode of the image capturing device has proved to be particularly advantageous, namely if the displayed operating state information represents at least the second operating parameter of the image sensor and/or of the image signal processing device and if the user can hereby already see in the standby mode which value has currently been set for the respective second operating parameter. The user can hereby easily recognize that the image capturing device cannot quickly be put into operation with a different value of the second operating parameter.

In some embodiments, the operating state information displayed at the electronic display can represent an upcoming servicing interval of the image capturing device. Such a servicing requirement can depend on a length of use and/or an intensity of use of the image capturing device or fixed time intervals can, for example, be provided. The control device of the image capturing device can monitor the need for a service in dependence on the length of use, the intensity of use, and/or the time lapse and can display corresponding information on the display. Since this displaying takes place in the standby mode of the image capturing device, the need for a service can in particular also be reliably perceived by the user outside the use of the image capturing device and a corresponding servicing time can be planned in good time. It is in particular important that the servicing interval is exactly observed in medical applications, in particular with an operating microscope or an electronic endoscope.

In some embodiments, the operating state information displayed on the electronic display can represent an operational error of the image capturing device that occurred last (e.g. time, error number). Problems can, for example, arise in the operating mode of the image capturing device that do not restrict or that only slightly restrict the use of the image capturing device and are therefore not specifically perceived or noticed by the user during the use of the image capturing device. Since, however, a corresponding displaying takes place on the display in the standby mode of the image capturing device, it is ensured with greater certainty that the respective error is perceived so that counter-measures can be initiated as soon as possible and the cause of the error can be eliminated. This contributes to increasing the reliability of the image capturing device on a subsequent use.

In some embodiments, the operating state information displayed at the electronic display can represent information on components of the image capturing device that have to be activated, connected, or set by the user on a new transition of the image capturing device into the operating state. These components can, for example, be units that are not required for every use of the image capturing device in the operating mode or that are removed or switched off in the standby mode. Such components can be fixed elements of the image capturing device or separate units that are, however, connected or connectable to the image capturing device. For example, such components can be a memory module (for storing image data), an electronic viewfinder, a monitor, a tripod, a power pack, a connection cable (for a signal transmission), or a supply cable (for the supply of electric energy). The displayed operating state information can in particular include information that the respective component of the image capturing device has to be connected or switched on so that this is not forgotten on the putting into operation of the image capturing device (operating mode) and/or so that a correct order is observed. The operating state information displayed at the electronic display can in particular comprise a checklist for a new transition of the image capturing device into the operating mode that can thus be consulted by the user in a simple manner. Such a checklist can be configured by the control device in dependence on the last detected operating state of the image capturing device.

In some embodiments, the operating state information displayed at the electronic display can represent information on a planned future use of the image capturing device. Information (for example the date, time, user, and/or project name) on such a planned future use that is stored by the control device as an updated operating state (reservation of the image capturing device for a subsequent operating mode) can in particular be transmitted to the control device in the operating mode of the image capturing device.

In some embodiments, a memory can be associated with the control device in which the operating state information that can be displayed is stored in different possible user languages and information on a desired one of the different user languages is also stored, with the control device being configured to control the display to display the operating state information in the desired user language. Country-specific or language-specific adaptations of the image capturing device can hereby be simplified,

The currentless information maintaining display can, as already explained, be configured for displaying text information and numerical information and/or comprise so-called electronic paper.

The image capturing device can have, in addition to the currentless information maintaining display, a further electronic display that is, however, shut down in the standby mode of the image capturing device. In the operating mode, in contrast, the further electronic display can serve to display operating state information in a conventional manner on a current operating state of the image capturing device (for example, the set exposure time, the set f-number, the set light sensitivity value, the set value of the image recording rate, etc.). The further electronic display can be configured to display such operating state information in a faster change or with a shorter latency time than the currentless information maintaining display, with the further electronic display, however, having to be continuously supplied with electric energy for this purpose. The further electronic display can also be configured for displaying text information and numerical information. The further electronic display can, for example, comprise a liquid crystal display (LED) or a light emitting diode display (LED display, in particular OLED display).

As regards the standby mode of the image capturing device, the standby mode of the image capturing device can comprise a shutdown mode in some embodiments in which the image capturing device is substantially switched off apart from an electronic monitoring of a switching on device. Alternatively or additionally, the standby mode or a further standby mode of the image capturing device can comprise an energy-saving mode (also called a hibernation mode) in which the image sensor and the image signal processing device are deactivated and the control device is active in a restricted manner relative to the operating mode (with a residual activity being possible).

The control device can be configured in some embodiments to control the display to display the operating state information before the image capturing device adopts the standby mode.

So that the control device can control the currentless information maintaining display to display the operating state information in the standby mode, the control device can be configured in some embodiments to read a preset operating state from a memory or to detect a currently set operating state of the image capturing device in the operating mode of the image capturing device and to control the display to display the corresponding operating state information when the image capturing device adopts the standby mode, in particular before the image capturing device adopts the standby mode.

The above-explained embodiments or a selection thereof can also be combined with one another to combine the respective advantages.

The invention will be explained in the following by way of example with reference to the drawing.

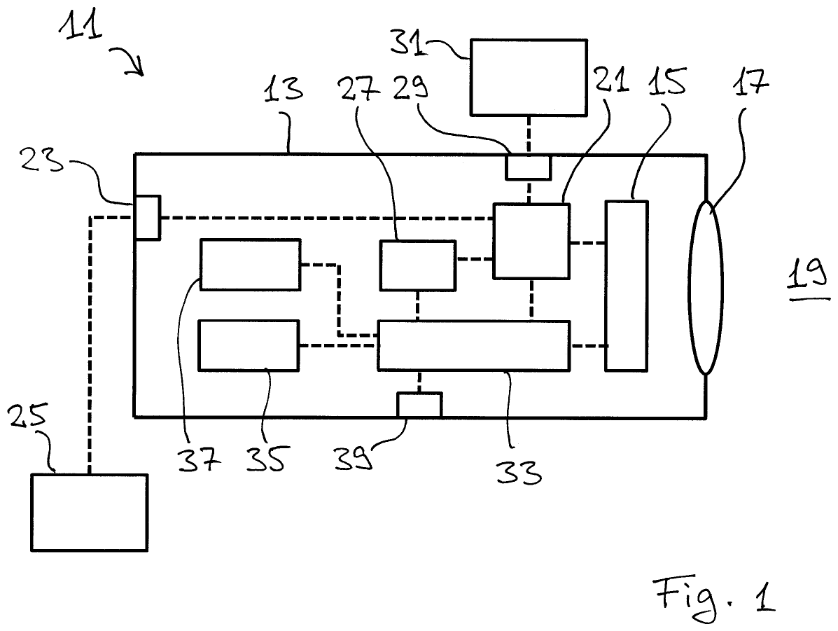

FIG. 1 shows a schematic representation of an image capturing device.

The image capturing device 11 shown in FIG. 1 serves to record image sequences. The image capturing device 11 comprises an image sensor 15 within a housing 13 and said image sensor 15 generates electronic image signals in an operating mode of the image capturing device 11. The image capturing device 11 furthermore comprises an imaging optics 17 that is positioned before the image sensor 15 and that generates an image of a recording zone 19 on the image sensor 15. An image signal processing device 21 arranged downstream of the image sensor 15 processes the image signals of the image sensor 15 in the operating mode of the image capturing device 11. The processed image signals can be output via a signal output 23 of the image capturing device 11, in particular at a connected image data recorder 25. The image signal processing device 21 is furthermore connected to an internal memory 27 in which the processed image signals can be alternatively or additionally stored. The memory 27 can be permanently or releasably fastened in or to the housing 13. The image signal processing device 21 is furthermore connected via a monitor output 29 to an optional electronic monitor 31.

The image capturing device 11 furthermore comprises a control device 33 that is connected to the image sensor 15, to the image signal processing device 21, to the memory 27, to a currentless information maintaining display 35, and to a further electronic display 37 to control these components. The currentless information maintaining display 35 can comprise so-called electronic paper (“e-ink display”). The further electronic display 37 can, for example, comprise a liquid crystal display that serves in a conventional manner to display operating state information on a current operating state of the image capturing device 11 (for example, the set exposure time, the set f-number). The further electronic display 37 has to be continuously supplied with electric energy for this purpose. The control device 33 is furthermore connected to an input device 39 via which a user can transmit control commands or settings to the control device 33.

In addition to the operating mode, the image capturing device 11 can adopt a standby mode (shutdown mode and/or energy-saving mode) in which the energy consumption is reduced with respect to the operating mode. In the standby mode, the image sensor 15, the image signal processing device 21, and the further electronic display 37 can, for example, be deactivated and the control device 33 can be active in a restricted manner relative to the operating mode or can likewise be deactivated.

The control device 33 controls the currentless information maintaining display 35 to display operating state information in the standby mode of the image capturing device 11 that represents an operating state of the image capturing device 11 that the image capturing device 11 will adopt after exiting the standby mode or after a new transition into the operating mode. This operating state thus displayed to the user can be based on a preset (resetting to a so-called default value). Provision can, for example, be made that a component (e.g. an illumination device) associated with the image capturing device 11 is always switched on after a restart. The operating state displayed in the standby mode can, however, also correspond to an operating state the image capturing device 11 had adopted before adopting the standby mode (maintenance of a last selected setting). A different procedure (e.g. after a new start, adopting preset values of some operating parameters and maintaining last set values of other operating parameters) can also be provided for different operating parameters or components of the image capturing device 11.

The operating state information displayed on the currentless information maintaining display 35 can, for example, comprise or represent one or more of the following pieces of information:
a state of components of the image capturing device 11;
a changeable operating parameter of the image sensor 15 and/or of the image signal processing device 21;
an operating parameter of the image sensor 15 and/or of the image signal processing device 21 that can only be changed by the user in that the image capturing device 11 is temporarily set into the standby mode starting from the operating mode and is subsequently set into the operating mode again;
an upcoming servicing interval of the image capturing device 11;
a last occurring operational error of the image capturing device 11;
information, in particular in the form of a checklist, on components of the image capturing device 11 that have to be activated, connected, or set by the user after a new transition of the image capturing device 11 into the operating mode; and/or
information on a planned later use of the image capturing device 11.

It is possible in this manner to bring information that is relevant to a fast and/or safe putting into operation of the image capturing device 11 to the knowledge of a user even in the standby mode of the image capturing device 11 and that can depend, however, depend on a last adopted changeable operating state of the image capturing device 11. The control device 33 can thus flexibly adapt the information displayed on the currentless information maintaining display 35 in dependence on, for example, predetermined or last carried out settings, on received information, or on commands, or in dependence on last occurring events. The image capturing device 11 can thus be operated fast and free of error starting from the standby mode.

The image capturing device 11 can be a digital video camera, a digital operating microscope, or a digital endoscope. In a use as a digital video camera, a shoulder support or an electronic viewfinder (not shown) can, for example, also be provided. In a use as a digital operating microscope, the image capturing device 11 can, for example, also comprise a tripod or can be fastened to a tripod (not shown).

### REFERENCE NUMERAL LIST

11 image capturing device
13 housing
15 image sensor
17 imaging optics
19 recording zone
21 image signal processing device
23 signal output
25 image data recorder
27 memory
29 monitor output
31 monitor
33 control device
35 currentless information maintaining display
37 further electronic display
38 input device

1. An image capturing device (11), in particular a digital video camera or a digital operating microscope, comprising
an electronic image sensor (15);
an image signal processing device (21) connected to the image sensor (15);
a control device (33); and
an electronic display;
wherein the image capturing device (11) is configured to selectively adopt an operating mode in which the image sensor (15) can be controlled to generate image signals or a standby mode in which an energy consumption of the image capturing device (11) is reduced relative to the operating mode,
wherein the electronic display is a currentless information maintaining display (35) that maintains displayed information in a currentless manner; and
wherein the control device (33) is configured to control the currentless information maintaining display (35) to display operating state information in the standby mode of the image capturing device (11), the displayed operating state information representing an operating state of the image capturing device (11) after exiting the standby mode.

2. An image capturing device (11) in accordance with claim 1,
wherein the displayed operating state information represents a state of components of the image capturing device (11).

3. An image capturing device (11) in accordance with claim 2,
wherein the displayed operating state information represents a state of components of the image capturing device (11) that are set upon resuming the operating mode or a state of components of the image capturing device (11) that were set before adopting the standby mode of the image capturing device (11).

4. An image capturing device (11) in accordance with claim 1,
wherein the displayed operating state information represents at least one of a changeable operating parameter of the image sensor (15) and a changeable operating parameter of the image signal processing device (21).

5. An image capturing device (11) in accordance with claim 1,
wherein the displayed operating state information represents an image format of generated image data or a data format of generated image data.

6. An image capturing device (11) in accordance with claim 1,
wherein a first operating parameter of the image sensor (15) and/or of the image signal processing device (21) is changeable by the user in the operating mode of the image capturing device (11) and a second operating parameter of the image sensor (15) and/or of the image signal processing device (21) can only be changed by the user in that the image capturing device (11) is set, starting from the operating mode, temporarily into the standby mode and subsequently back into the operating mode, with the displayed operating state information representing at least the second operating parameter of the image sensor (15) and/or of the image signal processing device (21).

7. An image capturing device (11) in accordance with claim 1,
wherein the displayed operating state information represents a servicing requirement of the image capturing device (11).

8. An image capturing device (11) in accordance with claim 1,
wherein the displayed operating state information represents a last occurring operational error of the image capturing device (11).

9. An image capturing device (11) in accordance with claim 1,
wherein the displayed operating state information represents information on components of the image capturing device (11) that have to be activated, connected, or set by the user upon resuming the operating mode of the image capturing device (11).

10. An image capturing device (11) in accordance with claim 1,
wherein the displayed operating state information represents information on a planned future use of the image capturing device (11).

11. An image capturing device (11) in accordance with claim 1,
wherein a memory is associated with the control device (33) in which the operating state information that can be displayed is stored in different possible user languages and information on a desired one of the different possible user languages is also stored, and with the control device (33) being configured to control the currentless information maintaining display (35) to display the operating state information in the desired user language.

12. An image capturing device (11) in accordance with claim 1,
wherein the currentless information maintaining display (35) comprises electronic paper.

13. An image capturing device (11) in accordance with claim 1,
wherein the image capturing device (11) has a further electronic display (37) that is switched off in the standby mode of the image capturing device (11).

14. An image capturing device (11) in accordance with claim 1,
wherein the standby mode of the image capturing device (11) is a shutdown mode in which apart from an electronic monitoring of a switching-on device the image capturing device (11) is substantially shut down.

15. An image capturing device (11) in accordance with claim 1,
wherein the standby mode of the image capturing device (11) is an energy-saving mode in which the image sensor (15) and the image signal processing device (21) are deactivated and the control device (33) is active in a restricted manner relative to the operating mode.

16. An image capturing device (11) in accordance with claim 1,
wherein the control device (33) is configured to read a preset operating state from a memory during the operating mode of the image capturing device (11), and to control the currentless information maintaining display (35) to display the read operating state information when the image capturing device (11) adopts the standby mode.

17. An image capturing device (11) in accordance with claim 1,
wherein the control device (33) is configured to detect a currently set operating state of the image capturing device (11) during the operating mode of the image capturing device (11), and to control the currentless information maintaining display (35) to display the detected operating state information when the image capturing device (11) adopts the standby mode.

18. An image capturing device (11) in accordance with claim 1,
wherein the control device (33) is configured to control the currentless information maintaining display (35) to display the operating state information before or on a transition from the operating mode into the standby mode so that the displaying of the operating state information is maintained in the standby mode.
